(19) United States
(12) Patent Application Publication
(10) Pub. No.: US 2025/0105425 A1
(43) Pub. Date: Mar. 27, 2025

(54) BATTERY CELL ASSEMBLY

(71) Applicant: GM Global Technology Operations LLC, Detroit, MI (US)

(72) Inventors: Tejas R. Bhavsar, Troy, MI (US); Mahesh A. Mummigatti, Bangalore (IN); Chenzhi Wang, Troy, MI (US); David R. Clark, Grosse Pointe Woods, MI (US); Ryan Patrick Hickey, Austin, TX (US)

(21) Appl. No.: 18/473,743

(22) Filed: Sep. 25, 2023

(51) Int. Cl. H01M 50/264; H01M 10/613; H01M 10/643; H01M 10/653; H01M 10/6568; H01M 50/107; H01M 50/213; H01M 50/291; H01M 50/367

(52) U.S. Cl. CPC H01M 50/264; H01M 10/613; H01M 10/643; H01M 10/653; H01M 10/6568; H01M 50/107; H01M 50/213; H01M 50/291; H01M 50/367

(57) ABSTRACT

A battery cell assembly includes a battery cell and a battery cell holder. The battery cell has a cell casing. The cell casing has an outer casing surface. The outer casing surface has a first plurality of grooves formed therein. The battery cell holder has a plurality of cell pockets. Each of the cell pockets has a wall. The wall has a wall surface. The wall surface has a second plurality of grooves that interact with the first plurality of grooves on the outer surface of the cell casing. The interaction of the first plurality of grooves on the cell casing with the second plurality of grooves on the wall of each of the plurality of cell pockets cooperates to prevent the battery cell from moving relative to the battery cell holder.

### INTRODUCTION

The present disclosure relates to a battery cell assembly and more particularly to a battery cell assembly that has a battery cell and a battery support structure.

A rechargeable energy storage system (RESS), for example a battery, typically includes one or more battery cells and a means to support or hold the battery cell. The battery cell is typically constructed with an anode material and a cathode material separated by an electrically insulative material. The battery may include many of the anode and cathode pairs separated with the insulative material. In one example of a battery cell, the anode material, separator material and cathode material (however many there are) are rolled up into a roll sometimes referred to as a “jelly roll”. The jelly roll is then inserted into a hollow metal casing or enclosure to protect the jelly roll from the ambient environment. The case also functions to contain an electrolyte fluid within the case and around the jelly roll. The battery cell is supported by a housing or the like. Typically, an adhesive is used to hold the battery cell in the housing.

A battery cell in an RESS may undergo an uncontrolled thermal event known as thermal runaway propagation (TRP). During a TRP event the battery cell may increase in temperature resulting in an increase in pressure. Increasing temperature and pressure in the case due to gas production may lead to the seal on the case to leak.

While current RESS systems achieve their particular purpose issues still exist. Accordingly, a new and improved RESS having a means to secure the battery cells in the support member or housing is needed. Moreover, an RESS that have battery cells that have a means to accommodate a TRP event is needed.

### SUMMARY

According to several aspects of the present disclosure, a battery cell assembly is provided. The battery cell assembly includes a battery cell and a battery cell holder. The battery cell has a cell casing. The cell casing has an outer casing surface. The outer casing surface has a first plurality of grooves formed therein. The battery cell holder has a plurality of cell pockets. Each of the cell pockets has a wall. The wall has a wall surface. The wall surface has a second plurality of grooves that interact with the first plurality of grooves on the outer surface of the cell casing. The interaction of the first plurality of grooves on the cell casing with the second plurality of grooves on the wall of each of the plurality of cell pockets cooperate to prevent the battery cell from moving relative to the battery cell holder.

In accordance with another aspect of the present disclosure, the battery cell assembly further includes a plurality of cooling channels, wherein each of the plurality of cooling channels are disposed in the wall of each of the plurality of cell pockets.

In accordance with another aspect of the present disclosure, the battery cell assembly further includes a thermal interface material disposed between each of the plurality of cooling channels and outer surface of the cell casing of the battery cell for promoting heat transfer from the battery cell to the plurality of cooling channels.

In accordance with another aspect of the present disclosure, the cell casing of the battery cell further includes a first and a second end, wherein a first plurality of the first plurality of grooves is formed in the cell casing surface at the first end of the cell casing and a second plurality of the first plurality of grooves are formed in the cell casing surface at the second end of the cell casing.

In accordance with another aspect of the present disclosure, the cell casing further comprises a first wall portion, wherein the first wall portion has a first wall thickness, and wherein the first plurality of grooves is formed in the first wall portion.

In accordance with another aspect of the present disclosure, the cell casing further comprises a second wall portion, wherein the second wall portion has a second wall thickness, and wherein the second wall thickness is less than the first wall thickness of the first wall portion.

In accordance with another aspect of the present disclosure, the second wall thickness of the second wall portion is disposed at one of the first end second ends of the cell casing.

In accordance with another aspect of the present disclosure, the wall of each of the plurality of cell pockets has first and a second end, wherein a first plurality of the second plurality of grooves are formed on the surface of the wall at the first end of each of the plurality of cell pockets and a second plurality of the second plurality of grooves are formed on the surface of the wall at the second end of each of the plurality of cell pockets.

In accordance with another aspect of the present disclosure, the battery cell holder further comprises a protrusion that extends from one of the first and second ends of the battery cell holder and wherein the protrusion and the end of the casing define a vent gas passage.

In accordance with yet another aspect of the present disclosure, a battery cell assembly has a battery cell, a battery cell holder, and a plurality of cooling channels. The battery cell has a cell casing. The cell casing has an outer casing surface and the outer casing surface has a first plurality of grooves formed therein. The battery cell holder has a plurality of cell pockets. Each of the cell pockets has a wall and the wall has a wall surface. The wall surface has a second plurality of grooves that interact with the first plurality of grooves on the outer surface of the cell casing. The interaction of the first plurality of grooves on the cell casing with the second plurality of grooves on the wall of each of the plurality of cell pockets cooperates to prevent the battery cell from moving relative to the battery cell holder. Moreover, the battery holder further includes a plurality of cooling channels. Each of the plurality of cooling channels are disposed in the wall of each of the plurality of cell pockets.

In accordance with yet another aspect of the present disclosure, the battery cell assembly further includes a thermal interface material disposed between each of the plurality of cooling channels and outer surface of the cell casing of the battery cell for promoting heat transfer from the battery cell to the plurality of cooling channels.

In accordance with yet another aspect of the present disclosure, the cell casing of the battery cell further includes a first and a second end. A first plurality of the first plurality of grooves is formed in the cell casing surface at the first end of the cell casing and a second plurality of the first plurality of grooves are formed in the cell casing surface at the second end of the cell casing.

In accordance with yet another aspect of the present disclosure, the cell casing further includes a first wall portion. The first wall portion has a first wall thickness, and the first plurality of grooves is formed in the first wall portion.

In accordance with yet another aspect of the present disclosure, the cell casing further includes a second wall portion. The second wall portion has a second wall thickness, and the second wall thickness is less than the first wall thickness of the first wall portion. Moreover, a portion of the cell casing, for example, the bottom of the cell casing separates from the cell casing at the second wall thickness to release a gas from the cell casing during a rise in internal temperature of the battery cell, for example, during a TRP event.

In accordance with yet another aspect of the present disclosure, the second wall portion is disposed at one of the first end and second end of the cell casing.

In accordance with yet another aspect of the present disclosure, the wall of each of the plurality of cell pockets has first and a second end. A first plurality of the second plurality of grooves is formed on the surface of the wall at the first end of each of the plurality of cell pockets and a second plurality of the second plurality of grooves are formed on the surface of the wall at the second end of each of the plurality of cell pockets.

In accordance with yet another aspect of the present disclosure, the battery cell holder further includes a protrusion that extends from one of the first and second ends of the battery cell holder. The protrusion and the end of the casing define a vent gas passage.

In accordance with still another aspect of the present disclosure, a battery cell assembly has a battery cell, a battery cell holder and a plurality of cooling channels. The battery cell has a cell casing. The cell casing has an outer casing surface and the outer casing surface has a first plurality of grooves formed therein. The cell casing has a first wall portion and a second wall portion, and the first wall portion has a first wall thickness, and the first plurality of grooves is formed in the first wall portion. The second wall portion has a second wall thickness. The second wall thickness is less than the first wall thickness of the first wall portion. The battery cell holder has a plurality of cell pockets. Each of the cell pockets has a wall and the wall has a wall surface. The wall surface has a second plurality of grooves that interact with the first plurality of grooves on the outer surface of the cell casing. The interaction of the first plurality of grooves on the cell casing with the second plurality of grooves on the wall of each of the plurality of cell pockets cooperate to prevent the battery cell from moving relative to the battery cell holder. Each of the plurality of cooling channels are disposed in the wall of each of the plurality of cell pockets.

In accordance with still another aspect of the present disclosure, the wall of each of the plurality of cell pockets has first and a second end. a first plurality of the second plurality of grooves are formed on the surface of the wall at the first end of each of the plurality of cell pockets. A second plurality of the second plurality of grooves are formed on the surface of the wall at the second end of each of the plurality of cell pockets.

In accordance with still another aspect of the present disclosure, the battery cell holder further includes a protrusion that extends from one of the first and second ends of the battery cell holder. The protrusion and the end of the casing define a vent gas passage.

### BRIEF DESCRIPTION OF THE DRAWINGS

The drawings described herein are for illustration purposes only and are not intended to limit the scope of the present disclosure in any way.

FIGS. 1 and 2, a perspective and top view of a battery cell assembly, illustrated in accordance with the present disclosure;

FIG. 3 a cross-sectional view through the battery cell assembly, as indicated in FIG. 2, illustrated in accordance with the present disclosure;

FIG. 3A is magnified view of the first plurality of grooves formed in the outer casing surface and the plurality of grooves formed in the cell pocket wall as shown in FIG. 3, in accordance with the present disclosure; and

FIG. 3B is magnified view the second plurality of grooves formed in the outer casing surface and a second plurality of grooves formed on the surface of the wall at the second end of each of the plurality of cell pockets, in accordance with the present disclosure.

### DETAILED DESCRIPTION

The following description is merely exemplary in nature and is not intended to limit the present disclosure, application, or uses.

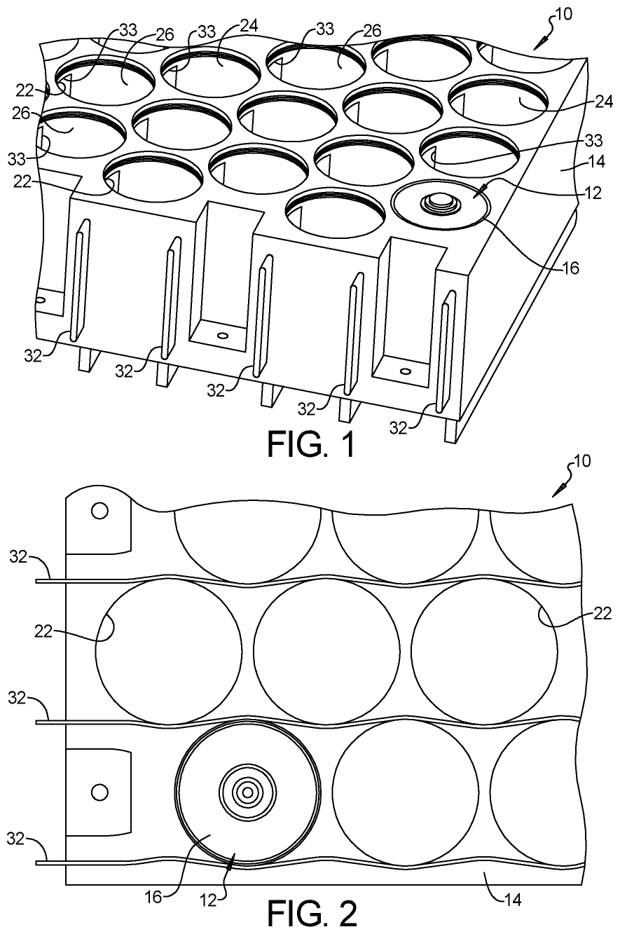

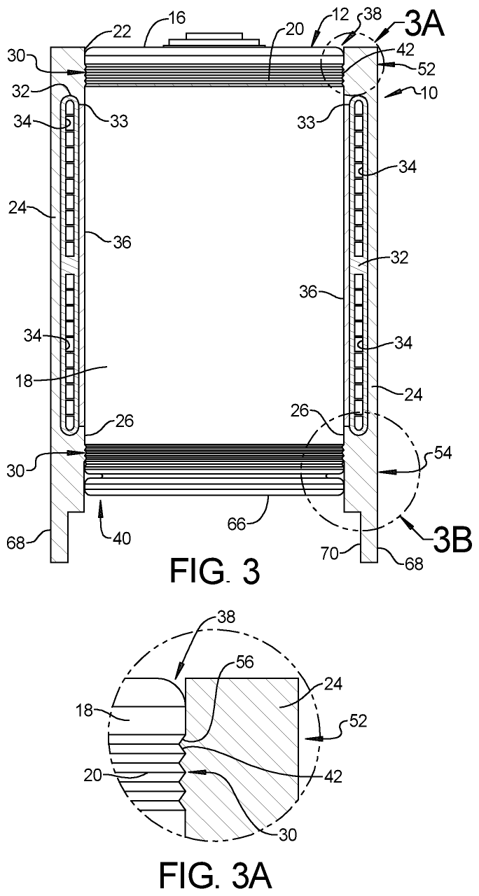

Referring now to FIGS. 1 and 2, a perspective and top partial view of a battery cell assembly 10 is illustrated, in accordance with the present disclosure. Battery cell assembly 10 includes a battery cell 12 and a battery cell holder 14. While only a partial view of the battery assembly 10 is shown one of ordinary skill in the art will appreciate that battery assembly 10 may be constructed, having the features as described below, of different sizes as required for the particular application. Battery cell 12 has a generally cylindrical shape and a hollow cylindrical cell casing 16. A jelly roll or Swiss roll design or assembly may be used to construct battery cell 12 where an insulated sheet (not shown) is arranged on a surface, a thin layer of anode material (not shown) is placed on top of the insulated sheet, a separator (not shown) is placed on top of the anode material and a cathode material (not shown) is placed on top of the separator. The jelly roll assembly forms a cylindrical rechargeable battery made, for example, of the following materials: nickel-cadmium (Ni—Cd), nickel-metal hydride (NiMH) and lithium-ion (Li-ion). The jelly roll assembly (not shown) is inserted into the hollow cylindrical cell casing 16. Cell casing 16 is sealed and metal contacts (not shown) are attached. A variety of devices including electric motors, for example, may be powered by battery cell 12 by connecting electrical wires from the device (i.e. electric motor) to the metal contacts of the battery cell 12.

A polymer such as nylon or other suitable material may be used to create or construct the cell holder 14. Moreover, any suitable manufacturing process may be used to form the cell holder 14 using the polymer, such as injection molding, 3D printing, vacuum forming and the like. The battery cell holder 14 has a plurality of cell pockets 22. The cell pockets 22 are generally cylindrical in shape and configured to hold one battery cell 12 in each of the cell pockets 22, as will be described in further detail below. More specifically, each of the cell pockets 22 have a pocket wall 24. The pocket wall 24 has a pocket wall surface 26. The pocket wall 24 and pocket wall surface 26 serve to hold or support the battery cell 12 as well as allow cooling of the battery cell 12 as further detailed below.

The battery cell holder 14 further includes a plurality of substantially flat and longitudinally extending cooling ribbons 32 for accepting and transporting heat generated by the battery cells 12 to a location outside of the battery assembly 10. Cooling ribbons 32 extend through the entire length of the cell holder 14 and each of the cooling ribbons run or are aligned adjacent each of the cell pockets 22. Each of the cooling ribbons 32 is made of a heat conductive material such as a metal. For example, cooling ribbon 32 is made of aluminum. The cooling ribbons 32 may be insert-molded or over molded in the battery cell holder 14 during a molding process of the battery cell holder 14. However, an opening or window 33 in the pocket wall 24 is provided adjacent the cooling ribbon 32 to allow thermal heat transfer from the battery cell 12 positioned in the cell pocket 22 to the cooling ribbon 32, as described below in greater detail. The present disclosure contemplates other methods for placing or positioning the cooling ribbons 32 in the cell holder 14, for example, the cooling ribbons 32 may be threaded through slots in the cell holder 14.

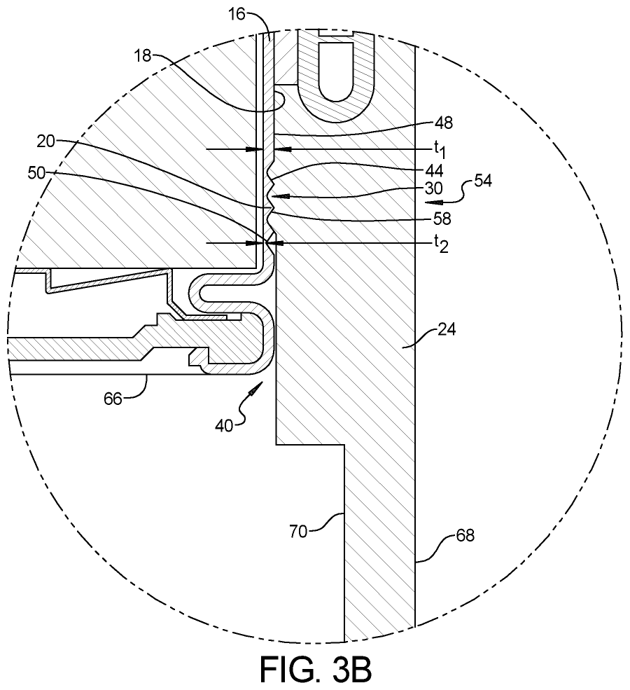

With additional reference to FIG. 3 a cross-sectional view through the battery cell assembly 10, at a location indicated in FIG. 2 is illustrated in accordance with the present disclosure. Cooling ribbons 32 have a plurality of cooling channels 34. Heat exchange fluid or coolant, such as ethylene glycol, diethylene glycol, propylene glycol or polyalkylene glycol or similar fluid, is circulated through each of the plurality of cooling channels 34 disposed in the pocket wall 24 of each of the plurality of cell pockets 22. The coolant circulating through cooling channels 34 accepts and transports the heat generated by the battery cell 12 to a location outside of the battery cell assembly 10 thereby cooling battery cells 12. Moreover, a thermal interface material 36 disposed in the opening or window 33 in wall 24 is provided between each of the cooling ribbons 32 and outer casing surface 18 of the cell casing 16 of the battery cell 12 to further promote heat transfer from the battery cell 12 to the coolant in the plurality of cooling channels 34. The present disclosure contemplates the use of commercially available thermal interface materials cut or shaped in the form of a sheet material or layer, such as, a thermally conductive acrylic interface pad offered by 3M™. In the present disclosure, the thermal interface material 36 contacts the outer casing surface 18 of the cell casing 16 of the battery cell 12 and a surface of the cooling ribbons 32. Cooling ribbons 32 may be connected to a heat exchanger (not shown) that dissipates the heat absorbed by the coolant in the cooling channels 34.

As shown in FIG. 3., the cell casing 16 of battery cell 12 has an outer casing surface 18. The outer casing surface 18 has a plurality of grooves 20 formed therein, as further illustrated in the expanded or magnified views of FIGS. 3A and 3B. The cell casing 16 of the battery cell 12 further includes a first and a second end 38, 40. A first plurality 42 of the plurality of grooves 20 is formed in the cell casing surface 18 at the first end 38 of the cell casing 16 and a second plurality 44 of the plurality of grooves 20 are formed in the cell casing surface 18 at the second end 40 of the cell casing 16.

Moreover, the cell casing 16 further includes a first wall portion 48. The first wall portion 48 has a first wall thickness “t₁”. The second plurality of grooves 44 are formed in the first wall portion 48, as shown in the expanded or magnified view of FIG. 3B. Additionally, the cell casing 16 includes a second wall portion 50. The second wall portion 50 has a second wall thickness “t₂”. The second wall thickness t₂ is less than the first wall thickness t₁ of the first wall portion 48. The second wall portion 50 is shown at the second end 40 of the cell casing 16, however, the present disclosure contemplates that second wall portion 50 may be disposed at one of the first end 38 and the second end 40 of the cell casing 16. The second wall thickness t₂ is configured to allow an end or bottom 66 of cell casing 16 to separate from the rest of the cell casing to allow gas buildup in the cell casing to be released.

With continuing reference to FIG. 3, the wall 24 of each of the plurality of cell pockets 22 of the cell holder 14 has a first end and a second end 52, 54. The wall surface 26 of wall 24 has a second plurality of grooves 30 that interact with the first plurality of grooves 20 on the outer surface 18 of the cell casing 16. More specifically, second plurality of grooves 30 include a first set of grooves 56, as shown in the expanded or magnified view of FIG. 3A, formed on the surface 26 of the wall 24 at the first end 38 of each of the plurality of cell pockets 22 and a second set of grooves 58 formed on the surface 26 of the wall 24 at the second end 40 of each of the plurality of cell pockets 22, as shown in the expanded or magnified view of FIG. 3B. The interaction of the first plurality of grooves 20 on the cell casing 16 with the second plurality of grooves 30 on the wall 24 of each of the plurality of cell pockets 22 cooperate to prevent the battery cell 12 from moving relative to the battery cell holder 14. The present disclosure contemplates adjusting the number of grooves 20, 30 to provide sufficient holding forces to retain battery cell 12 within the cell pocket 22 of battery holder 14. For example, the number of grooves in the cell casing 16 and the wall 24 of the cell holder 14 may be increased to increase the holding forces to retain the battery cell 12 in the battery cell holder 14.

The wall 24 additionally includes a plurality of protrusion 68 that extend from one of the first and second ends 52, 54 of the battery cell holder 14. The plurality of protrusions 68 at the end 54, for example, of the cell casing 16 define a vent gas passage 70. During an increase in temperature of the battery cell 12, referred to as a thermal runaway propagation (TRP) event, gas building up in the battery casing may be released into the vent gas passage 40 through the separation of the cell casing 16 at the reduced wall thickness t₂ in wall portion 50 of the wall 24.

The present disclosure also contemplates a battery cell 12 assembly process. The process includes a first step of a blanking operation. A second step of the process includes a deep drawing operation to extend the cylindrical battery casing 16. A third step includes extending the cylindrical battery casing 16 to an appropriate length. A fourth step includes a grooving operation on the extended cylindrical battery casing to form the grooves in the casing at the ends of the casing, for example. A fifth step in the process entails inserting the jelly roll with an anode and cathode collector into the casing. A sixth step involves filling the casing with the electrolyte. A seventh and final step in the process is crimping an end onto the casing to create a sealed battery enclosure or case 16.

The present invention has many advantages and benefits over current designs. For example, the interaction of the plurality of grooves 20 in the battery cell 12 with the plurality of grooves 30 in battery cell holder 14 minimizes cell movement in the vertical axis as compared to previous designs. Moreover, the plurality of grooves 20, 30 also act to center the battery cell 12 within the cell pocket 22 of battery cell holder 14. Additionally, the minimized vertical axis movement of battery cell 12 in the cell pocket 22 also minimizes bending of cell connectors or metal contacts. Furthermore, the assembly of the battery cells 12 into the battery cell holder 14 is easier and more precise as compared to current designs. For example, a set or plurality of battery cells 12 may be simultaneously placed in the battery cell holder using a series of suction cups attached to rotational arms that are in turn attached to a robot arm or arms. The rotational arms may be capable, for example, of rotating in multiple directions, i.e. roll, yaw, and pitch to provide efficient assembly of the battery cells 12 in the battery cell holder 14.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A battery cell assembly comprising:
a battery cell having a cell casing wherein the cell casing has an outer casing surface and wherein the outer casing surface has a first plurality of grooves formed therein;
a battery cell holder having a plurality of cell pockets, wherein each of the cell pockets has a wall and wherein the wall has a wall surface, wherein the wall surface has a second plurality of grooves that interact with the first plurality of grooves on the outer surface of the cell casing; and
wherein the interaction of the first plurality of grooves on the cell casing with the second plurality of grooves on the wall of each of the plurality of cell pockets cooperate to prevent the battery cell from moving relative to the battery cell holder.

2. The battery cell assembly of claim 1 further comprising a plurality of cooling channels, wherein each of the plurality of cooling channels are disposed in the wall of each of the plurality of cell pockets.

3. The battery cell assembly of claim 2 further comprising a thermal interface material disposed between each of the plurality of cooling channels and outer surface of the cell casing of the battery cell for promoting heat transfer from the battery cell to the plurality of cooling channels.

4. The battery cell assembly of claim 1 wherein the cell casing of the battery cell further comprises a first and a second end, wherein a first plurality of the first plurality of grooves is formed in the cell casing surface at the first end of the cell casing and a second plurality of the first plurality of grooves are formed in the cell casing surface at the second end of the cell casing.

5. The battery cell assembly of claim 4 wherein the cell casing further comprises a first wall portion, wherein the first wall portion has a first wall thickness, and wherein the first plurality of grooves is formed in the first wall portion.

6. The battery cell assembly of claim 5 wherein the cell casing further comprises a second wall portion, wherein the second wall portion has a second wall thickness, and wherein the second wall thickness is less than the first wall thickness of the first wall portion.

7. The battery cell assembly of claim 6 wherein the second wall thickness of the second wall portion is disposed at one of the first end second ends of the cell casing.

8. The battery cell assembly of claim 6 wherein the wall of each of the plurality of cell pockets has first and a second end, wherein a first plurality of the second plurality of grooves are formed on the surface of the wall at the first end of each of the plurality of cell pockets and a second plurality of the second plurality of grooves are formed on the surface of the wall at the second end of each of the plurality of cell pockets.

9. The battery cell assembly of claim 1 wherein the battery cell holder further comprises a protrusion that extends from one of the first and second ends of the battery cell holder and wherein the protrusion and the end of the casing define a vent gas passage.

10. A battery cell assembly comprising:
a battery cell having a cell casing wherein the cell casing has an outer casing surface and wherein the outer casing surface has a first plurality of grooves formed therein;
a battery cell holder having a plurality of cell pockets, wherein each of the cell pockets has a wall and wherein the wall has a wall surface, wherein the wall surface has a second plurality of grooves that interact with the first plurality of grooves on the outer surface of the cell casing; and
wherein the interaction of the first plurality of grooves on the cell casing with the second plurality of grooves on the wall of each of the plurality of cell pockets cooperate to prevent the battery cell from moving relative to the battery cell holder; and
a plurality of cooling channels, wherein each of the plurality of cooling channels are disposed in the wall of each of the plurality of cell pockets.

11. The battery cell assembly of claim 10 further comprising a thermal interface material disposed between each of the plurality of cooling channels and outer surface of the cell casing of the battery cell for promoting heat transfer from the battery cell to the plurality of cooling channels.

12. The battery cell assembly of claim 10 wherein the cell casing of the battery cell further comprises a first and a second end, wherein a first plurality of the first plurality of grooves is formed in the cell casing surface at the first end of the cell casing and a second plurality of the first plurality of grooves are formed in the cell casing surface at the second end of the cell casing.

13. The battery cell assembly of claim 12 wherein the cell casing further comprises a first wall portion, wherein the first wall portion has a first wall thickness, and wherein the first plurality of grooves is formed in the first wall portion.

14. The battery cell assembly of claim 13 wherein the cell casing further comprises a second wall portion, wherein the second wall portion has a second wall thickness, and wherein the second wall thickness is less than the first wall thickness of the first wall portion, wherein the a portion of the cell casing separates from the cell casing at the second wall thickness to release a gas from the cell casing.

15. The battery cell assembly of claim 14 wherein the second wall portion is disposed at one of the first end and second end of the cell casing.

16. The battery cell assembly of claim 15 wherein the wall of each of the plurality of cell pockets has first and a second end, wherein a first plurality of the second plurality of grooves are formed on the surface of the wall at the first end of each of the plurality of cell pockets and a second plurality of the second plurality of grooves are formed on the surface of the wall at the second end of each of the plurality of cell pockets.

17. The battery cell assembly of claim 10 wherein the battery cell holder further comprises a protrusion that extends from one of the first and second ends of the battery cell holder and wherein the protrusion and the end of the casing define a vent gas passage.

18. A battery cell assembly comprising:
a battery cell having a cell casing wherein the cell casing has an outer casing surface and wherein the outer casing surface has a first plurality of grooves formed therein, wherein the cell casing has a first wall portion an a second wall portion, wherein the first wall portion has a first wall thickness, wherein the first plurality of grooves is formed in the first wall portion, wherein the second wall portion has a second wall thickness, and wherein the second wall thickness is less than the first wall thickness of the first wall portion;
a battery cell holder having a plurality of cell pockets, wherein each of the cell pockets has a wall and wherein the wall has a wall surface, wherein the wall surface has a second plurality of grooves that interact with the first plurality of grooves on the outer surface of the cell casing; and
wherein the interaction of the first plurality of grooves on the cell casing with the second plurality of grooves on the wall of each of the plurality of cell pockets cooperate to prevent the battery cell from moving relative to the battery cell holder; and
a plurality of cooling channels, wherein each of the plurality of cooling channels are disposed in the wall of each of the plurality of cell pockets.

19. The battery cell assembly of claim 18 wherein the wall of each of the plurality of cell pockets has first and a second end, wherein a first plurality of the second plurality of grooves are formed on the surface of the wall at the first end of each of the plurality of cell pockets and a second plurality of the second plurality of grooves are formed on the surface of the wall at the second end of each of the plurality of cell pockets.

20. The battery cell assembly of claim 18 wherein the battery cell holder further comprises a protrusion that extends from one of the first and second ends of the battery cell holder and wherein the protrusion and the end of the casing define a vent gas passage.
